(19) United States
(12) Patent Application Publication
(10) Pub. No.: US 2003/0231300 A1
(43) Pub. Date: Dec. 18, 2003

(54) Laser power meter

(75) Inventor: Reinhard Kramer, Pfungstadt (DE)

Correspondence Address: THE FIRM OF KARL F ROSS, 5676 RIVERDALE AVENUE, PO BOX 900, RIVERDALE (BRONX), NY, 10471-0900, US

(73) Assignee: PRIMES GmbH

(21) Appl. No.: 10/353,801

(22) Filed: Jan. 28, 2003

(30) Foreign Application Priority Data
Jun. 13, 2002 (DE) 202 09 242.9

(51) Int. Cl. G01J 1/00

(52) U.S. Cl. 356/213

(57) ABSTRACT

A laser power meter has a laser-radiation absorber body of metal formed with a rotationally symmetrical depression open at the radiation-receiving side of the body. At the bottom of the depression a copper reflector of a cone shape is received. The body can be connected to a lid housing the detection and display circuitry by a joint which can be locked and from which tubes can run to the body and lid to carry the electrical conductors.

The innovation pertains to a laser power meter in a mobile and fixed form for power measurements on any kind of laser equipment.

According to the prior art, measurement of laser power is based on the rise in temperature of an irradiated block of metal (preferable aluminium or copper) during a defined irradiation time. The metal block serves as an absorber. In order to enlarge the absorber surface, the block has a depression on its irradiated side according to a possible/potential kind of design. In addition, in the prior art the inside surface is coated with aluminium oxide in order to increase the power density that can be absorbed. Nevertheless, the power density is limited, as the coating will be destroyed if the intensity is too great.

Therefore the underlying task of the innovation is to create an absorber that is able to absorb a larger power density and intensifying the removal of heat. According to the innovation, there is a reflector located in the depression of the absorber, widening the laser beam and thus reducing the power density. In this way the maximum capacity of the absorber will be increased and the maximum measurable power density raised.

It has proved best to situate the reflector in the middle of the depression, and a widening of the laser beam is especially productive if a reflector in the form of a cone to be chosen. An optimal widening and therefore spreading is achieved when the reflector cone is manufactured out of copper. Copper has a high thermal conductivity so that the heat will be fast drawn off, as well as a high melting point so that it can stand a higher power density. Additionally, copper possesses a high reflectivity so that together with the beam widening the allowable power density considerably increases.

The absorber in combination with the reflector according to the innovation is suitable for laser power meters of any size. To be mentioned is its suitability for a mobile, easy to handle power meter, developed for the daily usage, a so-called pocket power meter. This compact power measuring device consists of the absorber/reflector block described above, which in its idle position is covered by an approximately equal sized display electronics containing block. Both blocks are connected by line leading tubes, ending in a locking joint. In this way the absorber and the electronics are secured in the fold-up position and for measurements the device only needs its safety catch to be released and opened. Then the absorber as well as the display of the measuring equipment is released for measurement.

Further details of the innovation are described by drawings, videlicet:

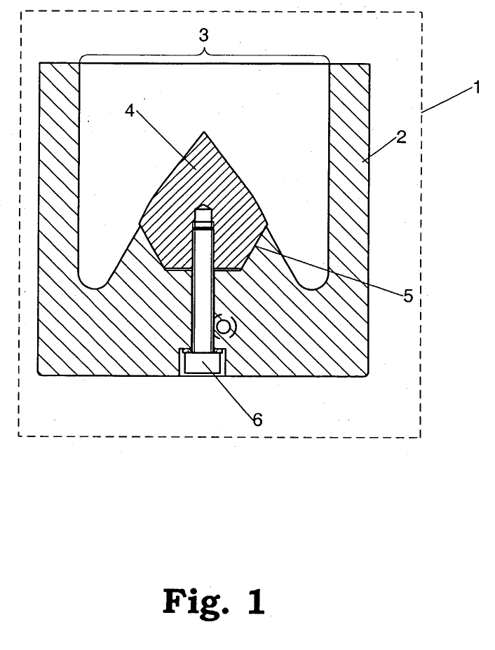

FIG. 1 the absorber/reflector block according to the innovation in section

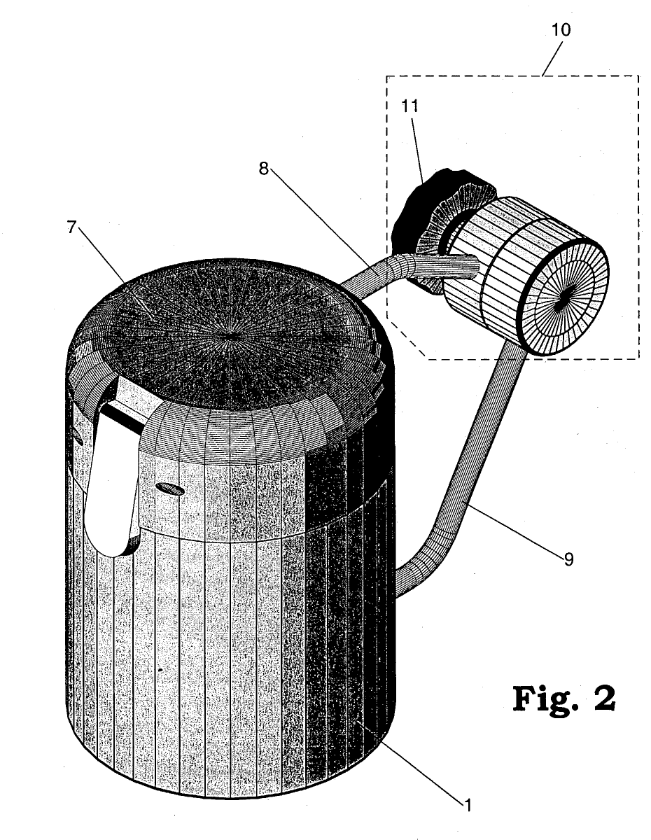

FIG. 2 the mobile laser power meter in fold-up position

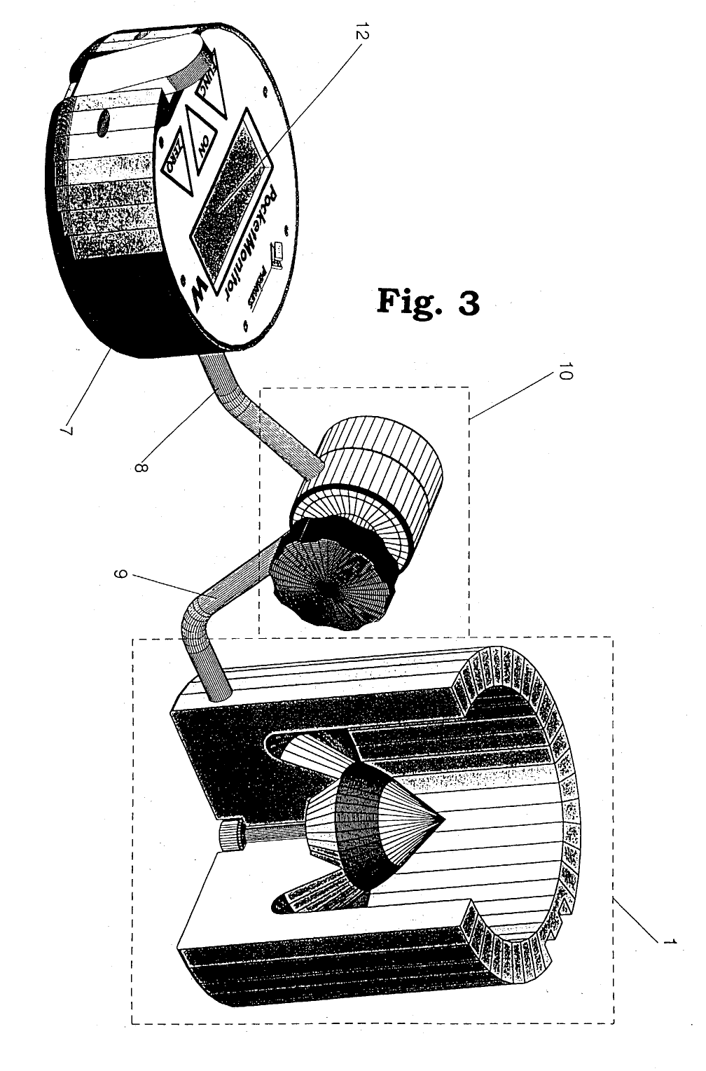

FIG. 3 the laser power meter in a perspective presentation.

The absorber 1 consists of the absorber block 2, preferably of aluminium, with a depression 3 on its irradiated side. The depression 3 is W-shaped, in order to enlarge the irradiated surface. The reflector 4, which is conical and preferably made of copper, is located in the centre of the base. The actual beam absorber in the form of an aluminium block 2 surrounds the reflector located in the centre. Both parts, that is the absorber and the reflector, are preferably rotationally symmetric. Initially the copper reflector, which can stand a very high power density, is irradiated. It reflects the rays, widening the beam at the same time. The from now on reduced power density will be safely absorbed by the absorber block 2.

The vertical angle α of the copper cone can be varied (at the time of manufacture) according to the customer's demand. The sides of the reflector 4 run into sloping surfaces 5 at the lower end, meshing in a corresponding location of the base of the absorber block 2. The cone is fixed by screw 6 penetrating the base of the absorber block 2, or any other suitable mean in the absorber block 2.

FIG. 2 shows a mobile laser power meter 13 in fold-up position. The absorber block 2 is combined with a lid 7, containing the measuring and display electronics. The outside dimensions of block 2 and lid 7 are matched with one another, whereby lid 7 fits on the block 2. Tubes 8 and 9 lead from lid 7 and from absorber 2 to joint 10 with the locking button. The tubes contain the lines, passing on the connection between the absorber block 2 to the measuring equipment in lid 7. The joint 10 in connection with the equipment of the tubes 8 and 9 ensures an accurate fit of the absorber block 2 and lid 7.

FIG. 3 shows the mobile laser power meter in its open position. For measurements of laser power the power meter will be opened. The depression of the absorber 3 is ready to take the beam and on the same level the measured data will be shown at the interior of the lid 7 on the monitor 12. The path of the connecting lines, which passes through the stiff and a joint containing conduit, is also visible. Its tuning enables a problem-free fold-up and the fit of the absorber 2 and lid 7, without affecting the electronics. The absorber 2 and lid 7 are optionally protected by a spring lock.

Additionally, the laser power meter might contain an interface for a connection to a data processing system, for instance interbus or can-bus. There is also the possibility for a connection via a current loop from 4 to 20 mA or by a voltage signal from 0-10 Volt.

Another model has a long distance set up using a cable instead of the tubes to enable absorber scale separation.

Compressed air or water can be used to achieve an accelerated cooling-off of the absorber.

I claim:

1. A laser power meter comprising:
a metal block forming an absorber capable of absorbing laser radiation and having an irradiation side, said block being formed with a depression opening at said irradiation side;
a reflector for laser radiation in said depression; and
electronic data measuring circuitry connected to said block for signalling laser power absorbed by said block.

2. The laser power meter defined in claim 1 wherein said reflector is at a center of said depression.

3. The laser power meter defined in claim 2 wherein said reflector has a shape of a cone.

4. The laser power meter defined in claim 3 wherein said reflector is made of copper.

5. The laser power meter defined in claim 4, further comprising a screw affixing said reflector to a base of said depression.

6. The laser power meter defined in claim 5 wherein said depression and said reflector are rotationally symmetrical and have a common axis of rotational symmetry.

7. The laser power meter defined in claim 6 wherein said electronic data measuring circuitry is received in a lid connected to said block and adapted to cover said depression, said lid being formed with a display for said circuitry.

8. The laser power meter defined in claim 7, further comprising a locking joint between said block and said lid, said locking joint having respective tubes containing electrical conductors and leading from said joint to said block and lid, respectively, for electrically connecting said block with said lid.

9. The laser power meter defined in claim 8 wherein said circuitry includes an interface for a data processing system.

10. The laser power meter defined in claim 6 wherein said circuitry includes a long-distance data cable between the absorber and said circuitry.

11. The laser power meter defined in claim 1, further comprising compressed air or water cooling for said absorber.

12. The laser power meter defined in claim 1 wherein said reflector is made of copper.

13. The laser power meter defined in claim 1 wherein said depression and said reflector are rotationally symmetrical and have a common axis of rotational symmetry.

14. The laser power meter defined in claim 1 wherein said electronic data measuring circuitry is received in a lid connected to said block and adapted to cover said depression, said lid being formed with a display for said circuitry.

15. The laser power meter defined in claim 14, further comprising a locking joint between said block and said lid, said locking joint having respective tubes containing electrical conductors and leading from said joint to said block and lid, respectively, for electrically connecting said block with said lid.

16. The laser power meter defined in claim 1 wherein said circuitry includes an interface for a data processing system.

17. The laser power meter defined in claim 1 wherein said circuitry includes a long-distance data cable between the absorber and said circuitry.
